(19) United States
(12) Patent Application Publication
(10) Pub. No.: US 2007/0100526 A1
(43) Pub. Date: May 3, 2007

(54) Method and device for activating a person protection system in a motor vehicle

(76) Inventors: Klaus Heimerl, Neutraubling (DE); Herbert Schober, Barbing-Friesheim (DE); Bernd Schorwerth, Regensburg (DE); Heiko Wahl, Bernhardswald-Hauzendorf (DE)

Correspondence Address: LERNER GREENBERG STEMER LLP, P O BOX 2480, HOLLYWOOD, FL, 33022-2480, US

(21) Appl. No.: 10/561,125

(22) PCT Filed: Oct. 20, 2005
(86) PCT No.: PCT/EP05/50771

§ 371 Date: Mar. 6, 2006

(30) Foreign Application Priority Data
Apr. 6, 2004 (DE) 10 2004 016 938.1

(51) Int. Cl. B60R 21/0136; B60K 28/10

(52) U.S. Cl. 701/45; 280/735; 180/274

(57) ABSTRACT

Disclosed are a method and a device for detecting the impact of a pedestrian on a vehicle. According to the invention, the pressures and/or deformations caused by an impact are measured using a sensor mechanism (1) located on the bumper, a first criterion (19) for deciding whether an impact of a pedestrian has occurred is formed from the output signal (a) of the sensor mechanism (1) with the aid of an evaluation means (2), and a decision as to whether a protective system (3) is to be triggered is made in accordance with said first criterion. The decision to trigger is made conditional upon the existence of a second criterion which is determined by a physical principle that is different from the sensor mechanism (1). The decision to trigger the protective system (3) is made only if both criteria are met.

The present invention relates to a method and a device for identifying the impact of an object with a motor vehicle, with a sensor device on the fender being used to measure the pressures and/or deformations caused by an impact and an evaluation means being used to form a first criterion from the output signal of the sensor device for deciding whether pedestrian impact has occurred, as a function of which an activation decision is made for a protection system.

Methods for identifying pedestrian impact with an automobile have been known for some time from the prior art. To protect a pedestrian from serious injury in the event of pedestrian impact with the front of the vehicle, it is known that one or more airbags can be provided on the engine hood or on the windshield, which are activated in the event of pedestrian impact. Another known protection measure in the event of pedestrian impact is to incline the engine hood at an angle to catch the pedestrian.

The solution provided by the protection devices mentioned is made a function of pedestrian impact being reliably identified and being able to be differentiated clearly from impacts involving other objects. To identify pedestrian impact, the kinematic principles of the pedestrian in the event of an impact with the front of an automobile are for example used. Generally the first point of contact for a pedestrian in the even of impact with a vehicle is the fender. A sensor device, which responds to the action of a force or a deformation, is there—the impels the pedestrian in a rotary manner, spinning said pedestrian onto the engine hood.

Reliable pedestrian protection is however only ensured, if the sensor device and its downstream means for evaluating the signals supplied by the sensor device operate reliably. An error in the sensor device or the means for evaluating the sensor signals could result in inadvertent activation of the protection system, so that it can no longer carry out its protection function.

The object of the present invention is therefore to specify a method and a device of the type mentioned above, which ensure the greatest possible reliability of the protection system in a simple manner.

This object is achieved with the features of the independent claims. Advantageous embodiments of the invention will emerge respectively from the dependent claims.

The reliability of the pedestrian protection system described above can advantageously be increased, if the results obtained by the means for evaluating the sensor signals from the sensor device only form a first criterion for deciding whether pedestrian impact has occurred. According to the invention the activation decision is made a function of compliance with a second criterion, which is determined by means of a physical principle that is different from the sensor device.

To this end the claimed device for identifying pedestrian impact has an evaluation unit, which is set up to process a signal supplied by a sensor and a value calculated by the evaluation means, to form from these the second criterion for deciding whether pedestrian impact has occurred, as a function of which a further activation decision is then made for the protection system, with a decision being made in favor of pedestrian impact if both the first and second decision criteria are satisfied.

By determining a further, second decision criterion based on a different physical principle in addition to the first, known decision criterion and making the decision a function of both decision criteria, it is possible with a high level of reliability to prevent the protection system being activated due to an error in the sensor device or the downstream evaluation means.

It is advantageous if the second criterion results from an assessment of a first against a second speed value. The first speed value is thereby advantageously determined by a sensor that is independent of the sensor device. The speed sensor, the signals from which are evaluated to display the vehicle speed in the vehicle, can advantageously be utilized for this purpose. In other words this means that the sensor that is independent of the sensor device does not represent an additional component but a sensor that is already present in every motor vehicle can be used. The signal emitted by the sensor is generally present at a bus for further evaluation and can be used for processing by the evaluation unit.

The second speed value could be provided by a further speed value. It is however particularly advantageous, if the second speed value is calculated by the evaluation means from the output signal emitted by the sensor device. The term “output signal” here also includes a number of signal values of one or more physical values. This procedure means that it is not necessary to use additional, similarly error-prone components.

It is particularly preferable, if the intrusion speed of the collision object, as determined or measured by the evaluation means, is used to calculate the second speed value. Determination of the intrusion speed is made possible by the use of sensor devices, which are set up to detect the temporal pattern of the collision and to transmit it to the evaluation means. The sensor devices used here are preferably fiber-optic sensors with pressure-dependent or deformation-dependent light transmission characteristics or a plurality of pressure sensors at intervals along the fender. As well as these specifically mentioned sensor types, it is of course also possible to use any sensor devices, which can be utilized to calculate or measure the intrusion speed from the signals transmitted by the sensor device.

According to one embodiment of the invention, the assessment of the first and second speed values includes verification of whether the second speed value is within a tolerance range around the first speed value. The assessment of the first and second speed values does not therefore simply represent a comparison of the calculated and measured values. Rather a tolerance range that has been determined beforehand, for example by experiment, is applied around the first speed value determined by the sensor. In the event of a collision this allows the rapidly changing vehicle speed, as for example caused by hard braking, to be taken into account. The size of the tolerance range is a function of the update rate of the sensor, which emits the first speed value as a signal. It is thereby true to say that the longer the interval between signal value updates, the larger the tolerance range has to be.

The evaluation means is thereby expediently set up to determine the intrusion speed of the collision object from the output signal supplied by the sensor device, in order to determine the vehicle speed from this and to transmit it as the second speed value to the evaluation unit.

The invention can therefore be seen to be a matter of increasing the reliability of a pedestrian protection system by making the decision, whether the protection system should be activated, require two criteria to be satisfied. The first criterion is determined by the sensor device and its downstream evaluation means. The manner in which the evaluation means achieves its result of whether pedestrian impact has occurred, i.e. which signals (pressure, deformation, acceleration, intrusion speed, impulse, deformation energy, etc.) are used, is hereby irrelevant. The second criterion is determined according to a different physical principle. In the present instance this is preferably done by assessing two speed values, one being supplied on the basis of a measured value and the other being supplied on the basis of a calculation by the evaluation means.

Further features, advantages and embodiments of the invention are described in more detail below with reference to the figures, in which:

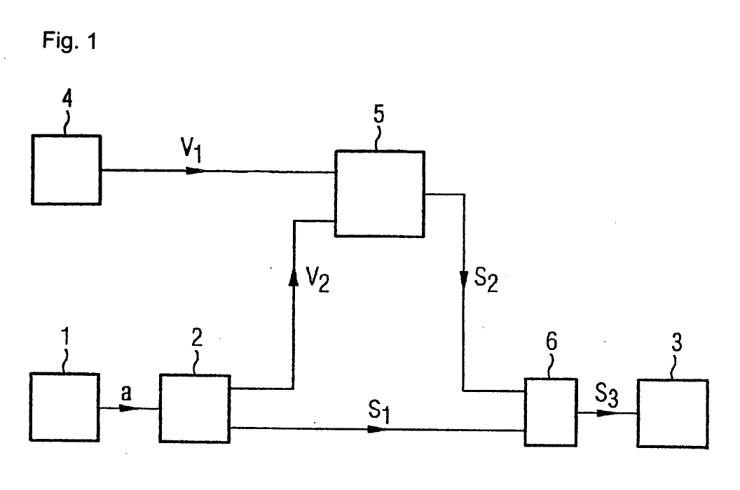

FIG. 1 shows a block circuit diagram of a device for identifying pedestrian impact and

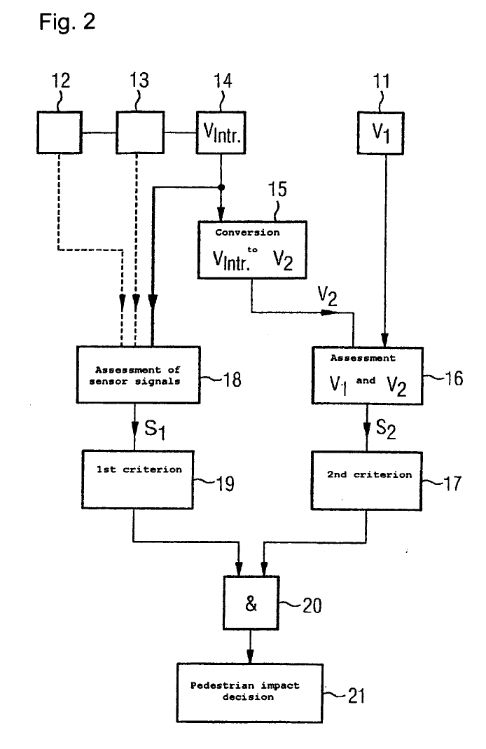

FIG. 2 shows a flow diagram of the method for identifying pedestrian impact.

FIG. 1 shows a block circuit diagram of a device and FIG. 2 shows a flow diagram of a method, with which pedestrian impact can be identified. The reference character 1 shows a sensor device, which can in principle be embodied in any manner but must be set up to detect the temporal pattern of a collision and to transmit a corresponding signal or corresponding signals a to an evaluation means 2. The sensor device can for example be a fiber-optic sensor with pressure-dependent or deformation-dependent light transmission characteristics. Such sensors have been known for some time from the prior art, so there is no need to describe them in more detail here. It is also possible to configure the sensor device 1 with a plurality of pressure sensors at intervals along a fender of the motor vehicle, such that the required temporal pattern of a collision can be detected. Such sensor devices are also known from the prior art. The evaluation means 2 works out from the signal(s) transmitted by the sensor device, whether a collision has occurred with a pedestrian or another object, e.g. a stone, a ball or another motor vehicle. If the assessment indicates that the colliding object is a pedestrian, a signal s₁, carrying the information to activate a protection system 3, is transmitted to a logic unit 6. The information coded in the signal s₁on its own does not however result in activation of the protection system 3.

To prevent incorrect activation of the protection system 3, e.g. due to a defective sensor device or an error in the evaluation means 2, the decision to activate must be “confirmed” by an evaluation unit 5. The evaluation unit 5 is connected to the evaluation means 2 and receives a speed value v₂ from this. The speed value v₂ represents a calculated vehicle speed. The calculation takes place within the evaluation means 2 from the intrusion speed, at which the colliding object penetrates the fender of the vehicle. The intrusion speed can be calculated from the signals a transmitted by the sensor device 1 or can be directly measured. The intrusion speed is determined as a function of the sensor used. As this is known from the prior art, there is no need for a detailed description at this point.

The evaluation unit 5 and the logic unit 6 can for example be configured in a common control device.

The decision to be made by the evaluation unit 5, whether pedestrian impact has occurred, is made by assessing the calculated speed value v₂ against a speed value v₁ measured by a sensor 4. The sensor 4 can be the speed sensor present in every vehicle, which transmits a speed value for example via a bus (possibly the currently standard CAN bus) to a computer unit (not shown in the figure), said speed value then being displayed on the tachometer.

The two speeds are assessed such that a tolerance range is applied around the measured speed value v₁, preferably distributed symmetrically around the measured speed value v₁. The breadth of the tolerance range is based on the update rate with which measured speed values v₁ are transmitted to the evaluation unit 5. The longer the interval between two updated speed values v₁, the larger the tolerance range has to be. The decision that pedestrian impact has occurred is only positive, if the calculated speed value v₂ is within this tolerance range. The tolerance range therefore prevents hard braking and a possibly not yet updated speed value v₁ causing a “no pedestrian impact” decision to be made even though such an impact has occurred.

The result of the assessment is transmitted by the evaluation unit 5 to the logic unit 6 (signal s₂). Only if the signals s₁, s₂ both correspond to “pedestrian impact”, is a signal s₃ transmitted by the logic unit 6 to the protection system 3, causing said protection system 3 to be activated. It is of secondary importance for the invention which type of protection system is thereby deployed.

The flow diagram in FIG. 2 shows a different representation of the described process. The sensor device 1 detects different input variables (sensor signals) 12,13. The evaluation means 2 can determine an intrusion speed v_{Intr} from these as a further input variable 14. The intrusion speed v_{Intr} can also represent a direct input variable, if it can be measured directly by the sensor device. Both the input variables 12, 13 (not described in more detail) and the input variable 14 can be used by the evaluation means 2 to decide whether pedestrian impact has occurred (reference character 18). The result of the assessment 18 is a first criterion 19, which is fed to an AND operation 20. The intrusion speed v_{Intr} determined as an input variable 14 is converted to a speed v₂ in the step 15 shown with the reference character. The calculated speed value v₂ and a measured speed value v₁ (reference character 11) undergo an assessment in step 16. The result of this assessment is a second criterion (reference character 17), which is also fed to the AND operation 20. Only if both the first and the second criteria correspond to pedestrian impact, is a signal emitted in step 21, so that a protection system can be activated.

1-11. (canceled)

12. A method for activating a person protection system in a vehicle, the method which comprises:
providing a sensor device on a bumper of the vehicle, measuring pressures and/or deformations caused by an impact, and outputting an output signal to an evaluation means;
forming a first criterion from the output signal of the sensor device for deciding whether pedestrian impact has occurred;
rendering a first activation decision for the protection system in dependence on the first criterion , wherein the first activation decision is valid independently;
forming a second criterion by assessing a first speed value, determined by a sensor independent of the sensor device, and a second speed value, calculated with the evaluation means, from the output signal of the sensor device;
rendering a second activation decision from the second criterion, wherein the second activation decision is valid independently; and
rendering an actual activation decision in dependence on the second activation decision.

13. The method according to claim 12, which comprises calculating the second speed value using an intrusion speed of a collision object determined by the evaluation means.

14. The method according to claim 12, wherein the step of assessing the first speed value and the second speed value includes verifying whether the second speed value is within a tolerance range around the first speed value.

15. A device for activating a person protection system in a motor vehicle, comprising:
at least one sensor device disposed on a fender of the motor vehicle for measuring pressures and/or deformations caused by an impact, said sensor device being configured to detect a temporal pattern of a collision and to output an output signal;
evaluation means connected to said sensor device for receiving the output signal of said sensor device, said evaluation means determining an intrusion speed of a collision object from the output signal of said sensor device, determining a vehicle speed from the intrusion speed, and outputting the vehicle speed as a speed value, for forming a first criterion for deciding whether pedestrian impact has occurred from the output signal, with the first criterion being used to render a first, independently valid, activation decision for the protection system;
an evaluation unit configured to process a signal supplied by a further sensor and the speed value calculated by said evaluation means, for forming therefrom a second criterion for deciding whether pedestrian impact has occurred, with the second criterion being used to render a second, independently valid, activation decision for the protection system;
a decision unit connected to said evaluation means and said evaluation unit and configured to emit an actual activation signal for the protection system, if the first and second activation decisions both correspond to an impact.

16. The device according to claim 15, wherein said further sensor is a speed sensor generating an output signal, the output signal is transmitted via a bus as a first speed value, and is provided to display a vehicle speed in the vehicle.

17. The device according to claim 15, wherein said sensor device is a fiber-optic sensor with pressure-dependent light transmission characteristics or a plurality of pressure sensors at intervals along the bumper.
